(19) United States
(12) Patent Application Publication
(10) Pub. No.: US 2021/0004815 A1
(43) Pub. Date: Jan. 7, 2021

(54) GENERATING PREDICTIONS FOR ELECTRONIC COMMUNICATIONS BY DETERMINING PROBLEM FEATURES BASED ON CONTEXTUAL INFORMATION ASSOCIATED WITH SERVICE SYSTEMS

(71) Applicant: Talkdesk, Inc., San Francisco, CA (US)

(72) Inventor: Jafar Adibi, Los Angeles, CA (US)

(21) Appl. No.: 16/553,450

(22) Filed: Aug. 28, 2019

Related U.S. Application Data
(63) Continuation of application No. 16/458,465, filed on Jul. 1, 2019.

(51) Int. Cl. G06Q 30/00; H04M 3/51; G06F 16/9032

(52) U.S. Cl. CPC G06Q 30/016; G06F 16/90332; H04M 3/5191; H04M 3/5166

(57) ABSTRACT

The present disclosure relates to systems, methods, and non-transitory computer readable media for generating purpose predictions and options for processing electronic communications. For example, the disclosed systems can determine a problem feature related to a service system corresponding to a contacting user based on contextual information associated with the service system. In addition, the disclosed systems can receive an electronic communication from a contacting user device and can determine contacting user information based on the received electronic communication. Further, the disclosed systems can generate a purpose prediction for the electronic communication based on the contacting user information and the contextual information. The disclosed systems can further determine options for processing the electronic communication.

### CROSS-REFERENCE TO RELATED APPLICATIONS

This application is a continuation of U.S. patent application Ser. No. 16/458,465 filed on Jul. 1, 2019. The contents of which are hereby incorporated by reference.

### BACKGROUND

Advancements in software and hardware platforms have led to a variety of improvements in systems that provide help tools and services to assist users in various contexts. For example, in the customer service context, digital assistant systems are now able to receive electronic communications from users and funnel users to appropriate departments based on various user input in response to automated questions. Amid efforts to improve these digital assistant systems, some systems can communicate with users via digital text-based communications (e.g., text messages or chats) to, at the outset of the correspondence, receive a user-entered synopsis of a query in text form and can provide the synopsis to an agent in an effort educate an agent on a user's situation quickly.

Despite these advances however, conventional digital assistant systems continue to suffer from a number of disadvantages, particularly in their efficiency, accuracy, and flexibility. Indeed, conventional systems inefficiently utilize computing resources by requiring an inordinate number of correspondences back and forth between a user and an agent. In many cases, a conventional digital assistant system processes several electronic communications between a user and an agent before an agent even understands the purpose behind the user's initial communication in the first place, much less arrives at, and guides the user through, a resolution. Thus, based on this type of onerous back-and-forth correspondence between a user and an agent, conventional systems require excessive computing power and computing time for processing each communication in such prolonged communication sessions.

In addition, conventional systems are often inaccurate. For example, many conventional digital assistant systems rely solely on information obtained from a user (e.g., via spoken dialogue or digital text) to determine a user query. Many of these conventional systems not only rely on a user's ability to articulate a query, but these systems further rely on a user's understanding of automated questions to provide input for determining where to direct the user to attempt to resolve the query. Even systems that enable a user to provide a text synopsis up-front rely on the user to accurately summarize their problem or query. As a result of relying too heavily on information obtained based on subjective user understanding, these conventional systems often inaccurately ascertain user queries, funnel users to incorrect departments, and/or altogether fail to resolve user problems.

Not only are conventional systems inaccurate in determining the correct department based on received user communications, but many conventional systems are further inaccurate from the perspective of agents as well. To elaborate, conventional systems often provide a user interface to an agent whereby the agent can communicate with, and access information related to, a contacting user (e.g., a caller). However, many of these conventional systems provide only basic user information such as a name and phone number. By providing only basic user information, these conventional systems provide little or no insight into a user's particular situation to more quickly arrive at a resolution. Because conventional digital assistant systems are capable of providing only generic information, these systems fail to provide the necessary granularity or specificity to accurately assess a user's situation and resolve the user's query in a more precise, incisive manner.

Further, conventional digital assistant systems are often inflexible. To illustrate, many conventional systems utilize a generic, one-size-fits all approach to determine and resolve a user query. Indeed, these systems cannot adapt to particular user circumstances to adjust how the system goes about resolving a user's query. Rather, these systems generally utilize the same automated questions to determine an appropriate department to funnel the user, whereupon the system connects the user with an agent who has little or no insight into the reason for the user's communication at the outset of their correspondence.

Thus, there are several disadvantages with regard to conventional digital assistant systems.

### SUMMARY

One or more embodiments described herein provide benefits and solve one or more of the foregoing or other problems in the art with systems, methods, and non-transitory computer readable media that generate options for processing an electronic communication based on determining contextual information and generating a purpose prediction for the electronic communication. The disclosed systems can determine contextual information from one or more service systems (e.g., a social networking system, an internet service provider system, etc.) related to a user. Based on the contextual information, the disclosed systems can determine a problem feature associated with a service system.

In addition, the disclosed systems can receive an electronic communication such as a phone call or chat message from a contacting user. In response to receiving the electronic communication, the disclosed systems can determine contacting user information associated with the contacting user including, but not limited to, a name, a geographic location, and service systems associated with the user. Based on the determined problem feature and the contacting user information, the disclosed systems can generate a purpose prediction for the electronic communication. For example, the disclosed systems can predict that the purpose for the contacting user sending the electronic communication is related to the problem feature identified from the contextual information. Additionally, the disclosed systems can determine one or more options for processing the electronic communication to, for example, accomplish the predicted purpose for the contacting user sending the electronic communication.

Additional features and advantages of the present application will be set forth in the description which follows, and in part will be obvious from the description, or may be learned by the practice of such example embodiments.

### BRIEF DESCRIPTION OF THE DRAWINGS

This disclosure will describe one or more embodiments of the invention with additional specificity and detail by referencing the accompanying figures. The following paragraphs briefly describe those figures, in which:

FIG. 1 illustrates an example environment for implementing a communication management system in accordance with one or more embodiments;

FIG. 2 illustrates an example sequence flow for generating a purpose prediction and determining options for processing an electronic communication in accordance with one or more embodiments;

FIG. 3 illustrates example systems in accordance with one or more embodiments;

FIG. 4 illustrates an example of a series of acts for determining options for processing an electronic communication in accordance with one or more embodiments;

FIG. 5 illustrates an example flow for generating a purpose prediction in accordance with one or more embodiments;

FIG. 6 illustrates an example option for processing an electronic communication in accordance with one or more embodiments;

FIG. 7 illustrates an example option for processing an electronic communication in accordance with one or more embodiments;

FIG. 8 illustrates a schematic diagram of a communication management system in accordance with one or more embodiments;

FIG. 9 illustrates a flowchart of a series of acts for determining options for processing an electronic communication in accordance with one or more embodiments;

FIG. 10 illustrates an example computing device in accordance with one or more embodiments; and

FIG. 11 illustrates an example communication system in accordance with one or more embodiments.

### DETAILED DESCRIPTION

One or more embodiments described herein provide benefits and solve one or more of the foregoing or other problems in the art with a communication management system that generates a purpose prediction for an electronic communication received from a contacting user device based on determining a problem feature from contextual information associated with a service system corresponding to the contacting user. The communication management system can determine a problem feature by receiving an indication of the problem feature from a service system and/or analyzing contextual information associated with the service system to identify the problem feature. The communication management system can further receive an electronic communication form a client device associated with a contacting user and, in turn, determine contacting user information associated with the contacting user. Further, the communication management system can generate a purpose prediction for the electronic communication based on the contacting user information and/or the contextual information. Additionally, the communication management system can determine an option for processing the electronic communication such as determining a resolution for the problem feature affecting the contacting user and/or connecting the contacting user with an agent to assist in resolving the problem feature.

As mentioned, the communication management system can determine a problem feature corresponding to a service system. In particular, the communication management system can determine a problem feature in the form of an issue with a particular service system such as a traffic jam associated with a traffic monitoring system, a service outage associated with an internet service provider system, or a power outage associated with a power distribution system. Additionally (or alternatively), the communication management system can determine a problem feature in the form of a broken feature or defective part of a product such as a smart appliance (e.g., a dishwasher or refrigerator).

To determine the problem feature, the communication management system can receive an indication of the problem feature from the service system (e.g., the traffic monitoring system, the internet service provider system, or the power distribution system). For example, the communication management system can receive, from a traffic monitoring system, a report of a traffic jam due to a traffic accident. The communication management system can also (or alternatively) receive an indication in the form of an outage report from a power distribution system and/or an internet service provider.

In some embodiments, the communication management system can determine a problem feature by analyzing contextual information associated with a service system. To illustrate, the communication management system can analyze information associated with a social networking system to identify various social media posts that mention bad traffic at a particular geographic location. Based on this information, the communication management system can determine that there is a problem feature and can define the problem feature as a traffic jam at that particular geographic location. In addition, the communication management system can utilize information from one service system in conjunction with information from another service system (or more than one other service system) to identify or determine a problem feature. For example, the communication management system can analyze social media posts together with traffic reports associated with a mobile application (e.g., WAZE) and/or news reports related to traffic accidents to determine correlations between the different contextual information from the various service systems. Thus, the communication management system can thereby determine a problem feature based on the collective contextual information from the various service systems.

As also mentioned, the communication management system can receive an electronic communication from a client device associated with a contacting user. Particularly, the communication management system can receive an electronic communication in the form of a phone call, a text message, an email, a chat message, or an instant message. Based on receiving the electronic communication, the communication management system can determine contacting user information for the contacting user. For example, the communication management system can determine contacting user information such as a name of the contacting user, a phone number, a username, or some other identifier for the contacting user, a gender of the contacting user, a geographic location associated with the contacting user device, and/or one or more service systems associated with the contacting user.

Additionally, the communication management system can generate a purpose prediction for an electronic communication. To elaborate, the communication management system can generate a prediction of why the contacting user would be contacting the communication management system in the first place. Indeed, the communication management system can generate a prediction based on various information such as contacting user information as well as contextual information. In some embodiments, the communication management system can determine a correlation between an identified problem feature and the contacting user information to predict that the contacting user is contacting the communication management system about the problem feature. For example, the communication management system can determine a correlation between a geographic location of a contacting user and a geographic location associated with an identified traffic jam. To expand this example, the communication management system can determine, based on contacting user information and contextual information, that the contacting user is not only stuck in traffic but that the contacting user also has a flight booked for a particular time that they are now likely to miss.

In some embodiments, the communication management system generates a purpose prediction based further (or alternatively) on communication dialogue of the electronic communication. Indeed, the communication management system can receive and analyze communication dialogue from the electronic communication in the form of verbally spoken words or digital text. In addition, the communication management system can analyze the communication dialogue to identify various parts of speech and to determine an overall topic of the communication dialogue. The communication management system can further utilize the topic in generating the purpose prediction for the electronic communication.

Further, the communication management system can determine, based on the purpose prediction, an option for processing a received electronic communication. In particular, the communication management system can generate options for accomplishing the purpose of the electronic communication. For example, the communication management system can determine that the purpose of an electronic communication is to reschedule a flight that the contacting user is going to miss due to bad traffic and can determine options to accomplish that purpose such as purchasing a new ticket or contacting an agent to help with the purchase of a new ticket. In some embodiments, the communication management system can automatically execute an option such as automatically purchasing a new ticket to reschedule a flight. In these or other embodiments, the communication management system can generate an agent transcript to provide to an agent user (e.g., an agent associated with a service system) based on the generated purpose prediction, identified contextual information, and/or contacting user information. Thus, the communication management system can connect the contacting user with an agent after getting the agent up to speed with the contacting user's situation ahead of time and providing the agent with a script pertinent to the contacting user's situation.

The communication management system provides several advantages over conventional systems. For example, the communication management system improves efficiency over conventional systems. To illustrate, the communication management system requires fewer communications or interactions to more quickly and efficiently determine purposes and resolutions for electronic communications, thereby reducing the processing time and processing power required to analyze, store, and transmit the excessive numbers of communications required by conventional systems.

As another advantage, the communication management system improves accuracy relative to conventional systems. More specifically, from the perspective of a contacting user, the communication management system more accurately determines purposes for electronic communications based on contextual information in conjunction with contacting user information. Thus, unlike conventional systems that rely solely on user to understanding in articulating a purpose for an electronic communication, the communication management system generates a predicted purpose based on more concrete contextual information. In addition, the communication management system improves accuracy for agent users as well. For example, the communication management system generates and provides an agent user interface that includes contacting user information, contextual information, and/or a generated purpose prediction. As a result, the communication management system more accurately informs an agent user as to why the contacting user is contacting the communication management system and how to help the contacting user in their particular situation.

Furthermore, the communication management system improves flexibility in relation to conventional systems. In particular, the communication management system flexibly adapts to individual contacting users. For example, the communication management system analyzes contextual information to adapt to particular circumstances and further analyzes contacting user information of a contacting user to determine correlations between the contacting user and any problem features determined from the contextual information. Thus, the communication management system generates predicted purposes tailored specifically to individual contacting users and generates options for processing electronic communications specific to the individual contacting users.

As illustrated by the foregoing discussion, the present disclosure utilizes a variety of terms to describe features and benefits of the communication management system. Additional detail is hereafter provided regarding the meaning of these terms as used in this disclosure. In particular, the term “contacting user” refers to a user that contacts the communication management system. A contacting user can refer to a user that is experiencing a problem or issue with a service system and that contacts the communication management system in an attempt to resolve the problem or to inform others of the problem. For example, a contacting user can include a caller, a chat user, or a text message user that sends an electronic communication to the communication management system. The term “electronic communication” refers to a communication such as a phone call, chat message, text message, instant message, or video call that the communication management system can receive from a contacting user.

As mentioned, the communication management system receives an electronic communication in relation to a problem or issue with a service system of a contacting user. As used herein, the term “service system” refers to a system that provides, monitors, manages, or maintains a product or service for a contacting user. For example, a service system can include a traffic monitoring system, a social networking system, an emergency reporting system, a home repair system, a weather monitoring system, an internet service provider system, an airline system, a transportation provider system, a news media system, a travel accommodation system, an electronic smart appliance distribution or monitoring system, or a power distribution or monitoring system.

As also mentioned, the communication management system determines contacting user information based on receiving an electronic communication from a contacting user. As used herein, the term “contacting user information” refers to information pertaining to or associated with a contacting user. Contacting user information includes information such as a name of a contacting user, a phone number, a username or other identifier of the contacting user, an age of a contacting user, a geographic location associated with a contacting user device (e.g., as determined by GPS, GALILEO, BEIDOU, GLONASS, or some other location-determining technology), and service systems information associated with the contacting user. For example, contacting user information can indicate a purchased airline ticket, a booked hotel room, a registered smart appliance or device, or other service system-related information associated with a contacting user.

As mentioned above, the communication management system analyzes contacting user information together with contextual information associated with service systems. As used herein, the term “contextual information” refers to information related to one or more service systems. To illustrate, contextual information can describe or provide context to various problem features of service systems. For example, contextual information includes information from social media posts, news articles, product defect reports or indications (e.g., error codes obtained from a smart appliance), product recalls, outage notifications, crowd-sourced information (e.g., crowd-sourced traffic information), weather information, flight monitoring information, and/or transportation or product availability information. Indeed, the communication management system can receive, from a service system, contextual information in the form of an indicator or report of a problem feature. In some embodiments, the communication management system can analyze various contextual information of one or more service systems to identify a problem feature without necessarily receiving a direct indication.

The term “problem feature” refers to a problem or issue associated with a service system. In particular, a problem feature can refer to a defect, anomaly, or circumstance that affects a contacting user. In some embodiments, a problem feature can refer to an issue that motivates a contacting user to contact the communication management system in the first place. For example, a problem feature can include a defective part or product, a traffic jam, a power outage, an internet service outage, a storm, a delayed or canceled flight, a sold-out product, an unavailable accommodation, or a product recall, among others.

As mentioned, the communication management system analyzes contextual information, problem features, and/or contacting user information to generate a purpose prediction. As used herein, the term “purpose prediction” refers to a prediction of a purpose or reason why the contacting user contacts the communication management system. In particular, a purpose prediction can describe a determination or prediction that the communication management system makes based on contextual information, problem features, contacting user information, and/or communication dialogue. A purpose prediction can include replacing a defective product, rescheduling a flight, changing a reservation, returning an item, inquiring about a power outage, reporting an internet service outage, or some other purpose for contacting the communication management system relating to a service system.

As mentioned, to generate a purpose prediction, in some embodiments the communication management system analyzes communication dialogue associated with an electronic communication. As used herein, the term “communication dialogue” refers to verbally spoken words and/or digital text included in an electronic communication. A communication dialogue can refer to words verbally spoken by a contacting user or can refer to a transcription of the verbally spoken works. Alternatively, a communication dialogue can refer to digital text from a text message, chat message, instant message, or email.

The communication management system can analyze communication dialogue to determine or identify a topic related to an electronic message. The term “topic” refers to a topic or subject of an electronic communication as indicated by communication dialogue. For example, a topic can include replacing a defective product, rescheduling a flight, changing a reservation, returning an item, inquiring about a power outage, reporting an internet service outage. Indeed, in some cases a topic can closely resemble a purpose prediction. Thus, by utilizing the determined topic in generating a purpose prediction, the communication management system can generate a purpose prediction with greater accuracy.

Additionally, the communication management system determines one or more options for processing an electronic communication. As used herein, the term “option” refers to an action or series of actions that the communication management system can take to process an electronic communication. In some embodiments, an option can refer to an automatic system-performed act to accomplish a purpose prediction, while in other embodiments an option can refer to an action to acquire help from another actor (e.g., an agent user or a service system) to accomplish a predicted purpose. For example, an option can include automatically executing the purchase of a new airline ticket, a rescheduling of transportation services, a return or replacement of a product, contacting an agent user to communicate with and help the contacting user, or some other action. Relatedly, the term “agent user” refers to an individual or system associated with the communication management system or a service system and that assists a contacting user via electronic communication correspondence. Indeed, the communication management system can connect a contacting user who needs to reschedule a flight with an agent user affiliated with the relevant airline system.

In some embodiments, the communication management system further generates an agent transcript to provide to an agent user. The term “agent transcript” refers to digital text that the communication management system generates based on a purpose prediction, contextual information, contacting user information, and/or communication dialogue. An agent transcript can include information directly applicable to a contacting user's situation to more quickly help the contacting user. The communication management system provides an agent transcript to an agent for an agent to read or otherwise provide to a contacting user.

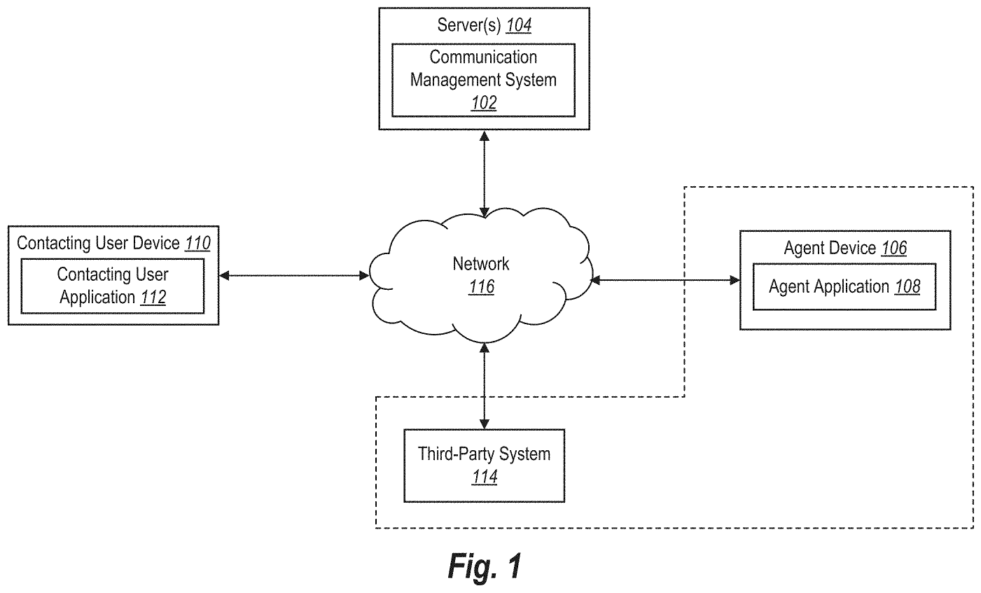

Additional detail regarding the communication management system will now be provided with reference to the figures. For example, FIG. 1 illustrates a schematic diagram of an example environment for implementing a communication management system 102 in accordance with one or more embodiments. An overview of the communication management system 102 is described in relation to FIG. 1. Thereafter, a more detailed description of the components and processes of the communication management system 102 is provided in relation to the subsequent figures.

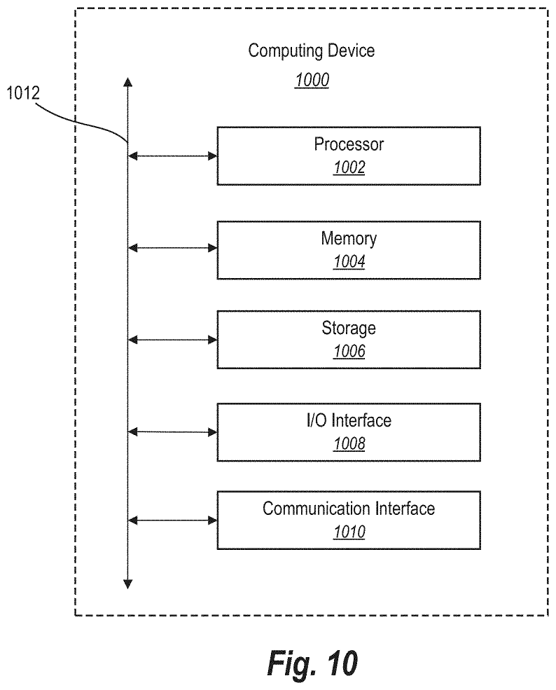

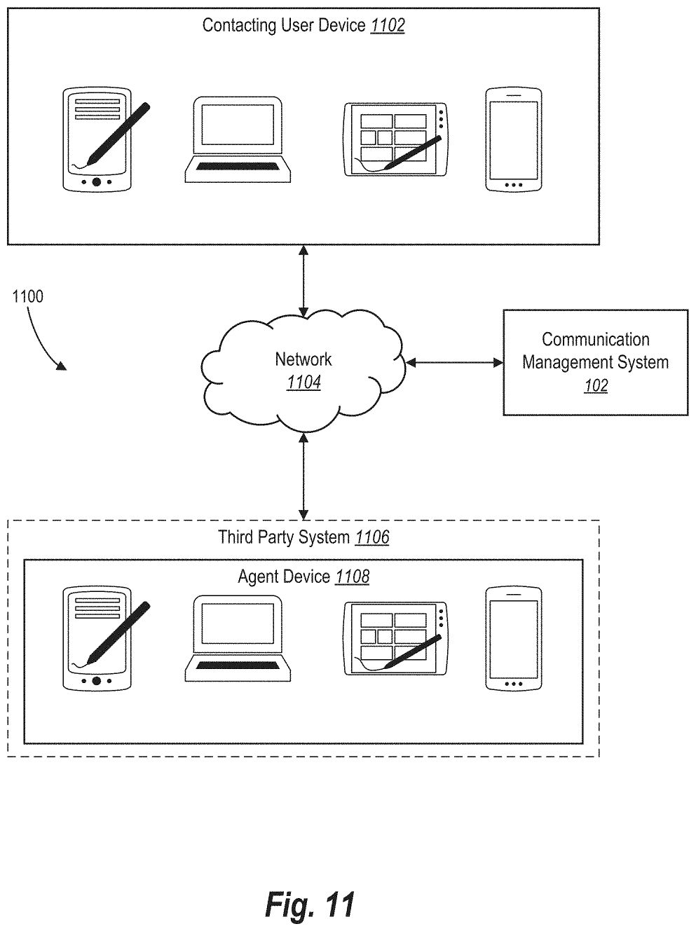

As shown in FIG. 1, the environment includes server(s) 104, an agent device, a contacting user device 110, a third-party system 114, and a network 116. Each of the components of the environment can communicate via the network 116, and the network 116 may be any suitable network over which computing devices can communicate. Example networks are discussed in more detail below in relation to FIGS. 10 and 11.

As mentioned, the environment includes different client devices such as a contacting user device 110 and an agent device 106. The contacting user device 110 can be a one of a variety of computing devices, including a smartphone, tablet, smart television, desktop computer, laptop computer, virtual reality device, augmented reality device, or other computing device as described in relation to FIGS. 10 and 11. Although FIG. 1 illustrates a single contacting user device 110, in some embodiments the environment can include multiple different contacting user devices, each associated with a different contacting user. The contacting user device 110 can receive user input and other information and provide the information (including communication dialogue and contacting user information) to the server(s) 104. Thus, the communication management system 102 on the server(s) 104 can receive information to use in generating purpose predictions and options for processing an electronic communication.

As shown, the contacting user device 110 includes a contacting user application 112. In particular, the contacting user application 112 may be a web application, a native application installed on the contacting user device 110 (e.g., a mobile application, a desktop application, etc.), or a cloud-based application where part of the functionality is performed by the server(s) 104. The contacting user application 112 can present or display information to a contacting user, including information relating to options for processing an electronic communication to help a contacting user accomplish a desired purpose. A contacting user can interact with the contacting user application 112 to provide user input to, for example, select an option for processing an electronic communication or provide communication dialogue.

As also mentioned, the environment includes an agent device 106. Like the contacting user device 110, the agent device 106 can be a one of a variety of computing devices, including a smartphone, tablet, smart television, desktop computer, laptop computer, virtual reality device, augmented reality device, or other computing device as described in relation to FIGS. 10 and 11. Although FIG. 1 illustrates a single agent device 106, in some embodiments the environment can include multiple different agent devices, each associated with a different agent user. The agent device 106 can receive user input from an agent user and receive information (including communication dialogue, contacting user information, a purpose prediction, and/or an agent transcript) from the server(s) 104.

As shown, the agent device 106 includes an agent application 108. In particular, the agent application 108 may be a web application, a native application installed on the agent device 106 (e.g., a mobile application, a desktop application, etc.), or a cloud-based application where part of the functionality is performed by the server(s) 104. The agent application 108 can present or display information to an agent user, including a user interface for interacting with a contacting user and presenting information pertaining to the contacting user (e.g., contextual information, an agent transcript, etc.). An agent user can interact with the agent application 108 to, for example, help a contacting user reschedule a flight or replace a defective product.

As illustrated in FIG. 1, the environment includes a third-party system 114. The third-party system 114 may be a service system or a different customer support system. For example, the third-party system 114 may be a service system that is currently experiencing or exhibiting a problem feature relevant to a contacting user. As another example, the third-party system 114 may be a service system that is not currently experiencing a problem feature but that a contacting user needs to contact to resolve an issue stemming from a problem feature of a different service system—e.g., an airline system that a contacting user calls to reschedule a flight due to being stuck in traffic. In some embodiments, as indicated by the dashed box of FIG. 1, the agent device 106 is associated or affiliated with the third-party system 114. In these embodiments, the communication management system 102 may provide information such as an electronic communication and contacting user information to the third-party system 114, whereupon the third-party system 114 may assign or relay the electronic communication to an agent device (e.g., the agent device 106). In other embodiments, the agent device 106 is not directly associated with the third-party system 114, and the communication management system 102 provides information to the agent device 106 without necessarily utilizing the third-party system 114.

As further illustrated in FIG. 1, the environment includes the server(s) 104. The server(s) 104 may generate, store, process, receive, and transmit electronic data, such as electronic communications, communication dialogue, contacting user information, contextual information, and purpose predictions. For example, the server(s) 104 may receive data from the contacting user device 110 in the form of an electronic communication and contacting user information. In addition, the server(s) 104 can transmit data to the agent device 106 to provide the electronic communication and contacting user information. The server(s) 104 can communicate with the contacting user device 110, the agent device 106, and the third-party system 114 to transmit and/or receive data via the network 116. In some embodiments, the server(s) 104 comprises an application server, a communication server, a web-hosting server, a social networking server, a digital content campaign server, or a digital content management server.

Although FIG. 1 depicts the communication management system 102 located on the server(s) 104, in some embodiments, the communication management system 102 may be implemented by (e.g., located entirely or in part) on one or more other components of the environment. For example, the communication management system 102 may be implemented by the contacting user device 110, the agent device 106, and/or the third-party system 114.

In some embodiments, though not illustrated in FIG. 1, the environment may have a different arrangement of components and/or may have a different number or set of components altogether. For example, the contacting user device 110, the agent device 106, and the third-party system 114 may communicate directly with the communication management system 102, bypassing the network 116. Additionally, the communication management system 102 can include one or more databases (e.g., a database to store contacting user information, contextual information, and/or generated purpose predictions) housed on the server(s) 104 or elsewhere in the environment. The communication management system 102 can be implemented in a variety of different ways across the server(s) 104, the network 116, the agent device 106, the contacting user device 110, and the third-party system 114. Additional detail regarding implementing different components of the communication management system 102 across devices is provided below.

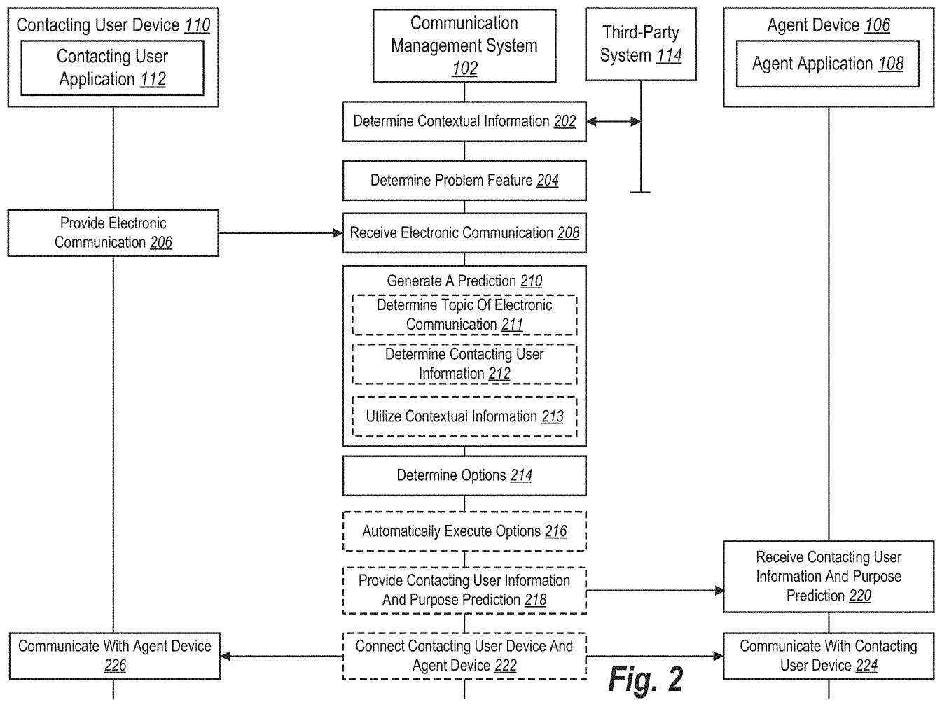

As mentioned above, the communication management system 102 generates a prediction of a purpose of an electronic communication and determines options to process the electronic communication to, for example, accomplish the predicted purpose. To that end, FIG. 2 illustrates a sequence flow of a series of acts performed by various components interacting with the communication management system 102.

As shown in FIG. 2, the communication management system 102 interacts with the third-party system 114 to perform an act 202 to determine contextual information. In particular, the communication management system 102 determines contextual information relating to status of the third-party system and/or a different system. For example, the communication management system 102 determines contextual information pertaining to any issues or problems with the third-party system 114 itself or with a different service system associated with a contacting user. To determine contextual information, in some embodiments the communication management system 102 receives the contextual information from the third-party system 114. In other embodiments, the communication management system 102 accesses contextual information stored by the third-party system 114 and/or monitors the third-party system 114 for any changes in status or indications of issues, anomalies, or other pertinent information. Although FIG. 2 illustrates a single third-party system 114, in some embodiments the communication management system 102 determines contextual information from more than one different third-party system.

In addition, the communication management system 102 performs an act 204 to determine a problem feature. More particularly, the communication management system 102 determines a problem feature based on the contextual information. Indeed, the communication management system 102 determines, based on contextual information that indicates an issue with the third-party system 114 or a different service system. For example, the communication management system 102 analyzes contextual information such as social media posts and crowd-sourced traffic information (e.g., via a mobile application such as WAZE) that indicate bad traffic along 1-5 near Los Angeles. Based on this contextual information, the communication management system 102 determines a problem feature in the form of a traffic jam at a particular geographic location on I-5.

In some embodiments, the communication management system 102 receives an indication of a problem feature from the third-party system 114. For example, the communication management system 102 receives a report of a traffic jam from a traffic monitoring system or a report of a power outage from a power distribution system. In other embodiments, the communication management system 102 determines the problem feature without necessarily receiving a direct indication of the problem feature. In these embodiments, the communication management system 102 identifies a problem feature by extrapolating from contextual information. Similar to the above example, the communication management system 102 identifies a traffic jam (i.e., the problem feature) by determining a correlation between a geographic location along 1-5, social media posts reflecting bad traffic near that location, and/or crowd-sourced traffic information indicating a traffic accident or other event resulting in bad traffic at the location.

As shown in FIG. 2, the communication management system 102 performs an act 208 to receive an electronic communication from the contacting user device 110. For the communication management system 102 to receive the electronic communication, the contacting user device 110 performs an act 206 to provide the electronic communication. For example, the contacting user device 110 transmits a phone call, a video call, or a digital text-based message to the communication management system 102. In response, the communication management system 102 receives the electronic communication. For instance, the communication management system 102 receives the phone call, video call, or digital text-based message.

As further shown in FIG. 2, the communication management system 102 performs an act 210 to generate a prediction. More specifically, the communication management system 102 generates a purpose prediction for the received electronic communication. Indeed, the communication management system 102 generates a prediction of a purpose or reason why a contacting user associated with the contacting user device 110 would send an electronic communication to the communication management system 102. As illustrated by acts 211-213, the communication management system 102 can utilize one or more various techniques as part of generating the purpose prediction.

For example, in some embodiments the communication management system 102 performs an act 211 to determine a topic of the received electronic communication. More specifically, the communication management system 102 analyzes communication dialogue from the electronic communication such as digital text. Indeed, in cases where the communication management system 102 receives a phone call or video call, the communication management system 102 converts verbally spoken words into digital text to analyze the digital text. In some embodiments, the communication management system 102 analyzes the digital text using natural language processing techniques to identify various parts of speech (e.g., nouns, adjectives, verbs, etc.). Based on the parts of speech, the communication management system 102 determines a topic of the electronic communication. For instance, by identifying various parts of speech from a phone call received from the contacting user device 110, the communication management system 102 determines a topic such as rebooking a flight or returning a product.

In the same or other embodiments, as part of generating a purpose prediction, the communication management system 102 performs an act 212 to determine contacting user information. Particularly, the communication management system 102 determines contacting user information based on receiving the electronic communication from the contacting user device 110. For example, the communication management system 102 determines contacting user information from the contacting user device 110 and/or a contacting user profile. Indeed, the communication management system 102 maintains a profile for a contacting user that includes a name of the contacting user, contact information (e.g., phone number, username or other identifier) for the contacting user, and associated service systems. For instance, the communication management system 102 determines which service systems a contacting user utilizes and are therefore relevant to the contacting user as potential sources of future issues. Additionally, the communication management system 102 obtains information from the contacting user device 110 such as a geographic location obtained via GPS, GLONASS, or by some other location-determining technology.

In these or other embodiments, as part of generating a purpose prediction, the communication management system 102 performs an act 213 to utilize contextual information. In particular, the communication management system 102 utilizes the contextual information determined in act 202 to use as a basis for generating a purpose prediction. To elaborate, the communication management system 102 determines that, based gathering contextual information from the third-party system 114 (and potentially other service systems as well), the purpose for the electronic communication is related to the problem feature determined from the contextual information. As an example, the communication management system 102 determines a correlation between a geographic location of the contacting user device 110 on I-5 near Los Angeles and social media posts indicating bad traffic near that location, and further determines that, because the contacting user has a flight booked at a time in the near future, the contacting user is likely to miss the flight and needs to reschedule. Thus, the communication management system 102 determines that the purpose of the electronic communication is to reschedule a flight for a later time.

By utilizing these various techniques to generate a purpose prediction, the communication management system 102 accurately predicts a reason why the contacting user sends an electronic communication to the communication management system 102. For example, by determining a topic of the electronic communication (act 211), the communication management system 102 determines that the reason why the contacting user contacted the communication management system 102 in the first place is related to the determined topic. Additionally (or alternatively), by determining contacting user information (act 212), the communication management system 102 compares the contacting user information with known problem features to determine whether the problem features are relevant to the contacting user as a purpose for initially sending the electronic communication. Indeed, by utilizing contextual information (act 213), the communication management system 102 determines which problem features are relevant to the contacting user.

As illustrated in FIG. 2, the communication management system 102 further performs an act 214 to determine options. Particularly, the communication management system 102 determines options for processing the received electronic communication. Indeed, based on the generated purpose prediction, the communication management system 102 determines options for how to accomplish the purpose of the electronic communication. For example, for the contacting user that needs to rebook a flight, the communication management system 102 determines one or more options for rebooking the flight.

In some embodiments, the communication management system 102 determines an option to be performing whatever acts necessary to overcome the relevant problem feature (e.g., purchasing a new ticket). Thus, in some embodiments the communication management system 102 automatically executes one or more actions on behalf of the contacting user to help the contacting user overcome the problem feature and resolve an issue. For instance, in these embodiments, the communication management system 102 automatically purchases a new ticket for the contacting user by contacting the appropriate airline, changing the contacting user's ticket, and providing (to the contacting user device 110) a notification of the changed flight. In other embodiments, the communication management system 102 determines an option of contacting an agent user to inform the agent user of the contacting user's situation, whereupon the agent user can resolve any issues with or without communicating with the contacting user.

Indeed, as illustrated in FIG. 2, in some embodiments the communication management system 102 performs an act 216 to automatically execute options. More specifically, the communication management system 102 automatically performs (i.e., performs without additional user input) one or more actions to help the contacting user overcome the determined problem feature. As mentioned, the communication management system 102 automatically rebooks a flight for a contacting user who is calling because they are going to miss their flight because of bad traffic. Other examples of automatically executing options include automatically purchasing a replacement product, automatically reporting a service outage, or automatically canceling a reservation.

Additionally (or alternatively), the communication management system 102 performs an act 218 to provide contacting user information and a purpose prediction to an agent device 106. To elaborate, in cases where the communication management system 102 determines to contact an agent user about the contacting user's situation, the communication management system 102 provides various information to the agent device 106 associated with the agent user. For instance, the communication management system 102 provides contacting user information and a generated purpose prediction for display on the agent device 106. In some embodiments, the communication management system 102 provides additional or alternative information to the agent device 106 such as determined options for processing the electronic communication (e.g., as determined in act 214).

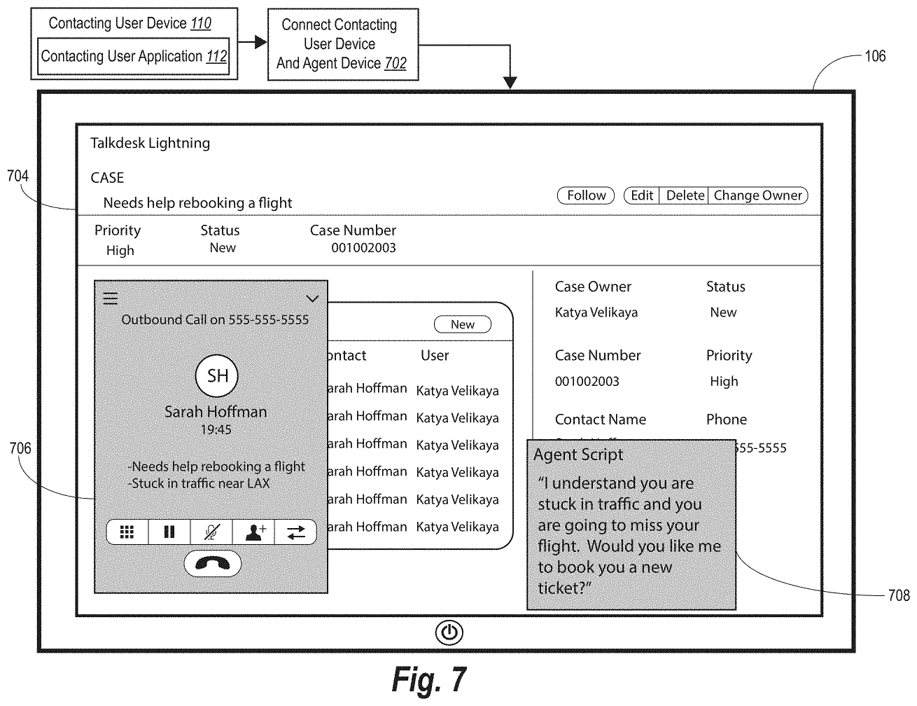

In turn, the agent device 106 performs an act 220 to receive the contacting user information, the purpose prediction, and/or determined options. Thus, the communication management system 102 informs the agent user of pertinent information outlining the contacting user's circumstances and how to help the contacting user overcome or resolve issues relating to the problem feature. Additional detail regarding information provided to the agent device 106 is provided below with reference to FIG. 7.

As further illustrated in FIG. 2, in some embodiments the communication management system 102 performs an act 222 to connect the contacting user device 110 and the agent device 106. For example, the communication management system 102 transmits messages (e.g., phone messages, video, messages, and/or digital text-based messages) from the contacting user device 110 to the agent device 106 and vice-versa. Thus, the communication management system 102 facilitates communication between the contacting user device 110 and the agent device 106. As a result, the contacting user device 110 can perform an act 226 to communicate with the agent device 106, and the agent device 106 can perform an act 224 to communicate with the contacting user device 110.

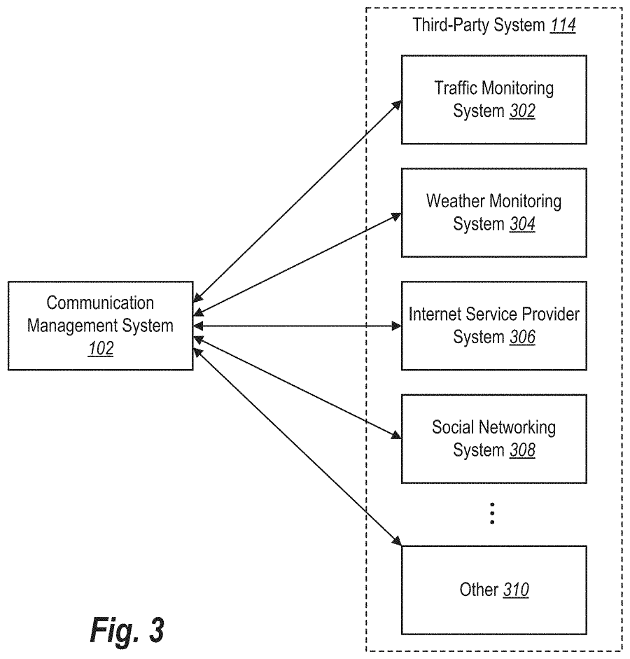

As mentioned above, the communication management system 102 determines contextual information associated from the third-party system 114, where the contextual information is related to the third-party system 114 or some other service system. FIG. 3 illustrates example service systems for the third-party system 114. In some embodiments, however, the communication management system 102 receives or otherwise obtains information from third-party system 114 about a service system apart from the third-party system 114. For example, the communication management system 102 analyzes social media posts from a social networking system, where the posts reflect information about traffic or the weather.

As illustrated in FIG. 3, the communication management system 102 communicates with the third-party system 114 to determine contextual information. As shown, the third-party system 114 (or other service system) can be a traffic monitoring system 302, a weather monitoring system 304, an internet service provider system 306, a social networking system 308, or some other system 310 (as described above).

To determine contextual information from the third-party system 114, the communication management system 102 interfaces with the third-party system 114 to receive status updates, problem reports, monitoring information, messages, or other information. For example, the communication management system 102 determines contextual information by monitoring social media posts, product sales information, weather information, traffic information, or other types of information. In some embodiments, the communication management system 102 receives reports or other indications from the third-party system 114. For instance, the communication management system 102 receives reports of problem features such as traffic jams, power outages, product recalls, etc.

In these or other embodiments, the communication management system 102 determines a problem feature by extrapolating the problem feature based on contextual information. Indeed, some contextual information does not directly indicate a problem feature via a report or other affirmative indication, but the communication management system 102 nonetheless determines correlations between various contextual information to deduce or draw conclusions about problem features. For example, the communication management system 102 determines a correlation between social media posts about a storm in Los Angeles and information about flight delays from an airline system to determine a problem feature of late flights for various other locations (e.g., locations with flights that come from or connect with Los Angeles) as a result of the storm in Los Angeles.

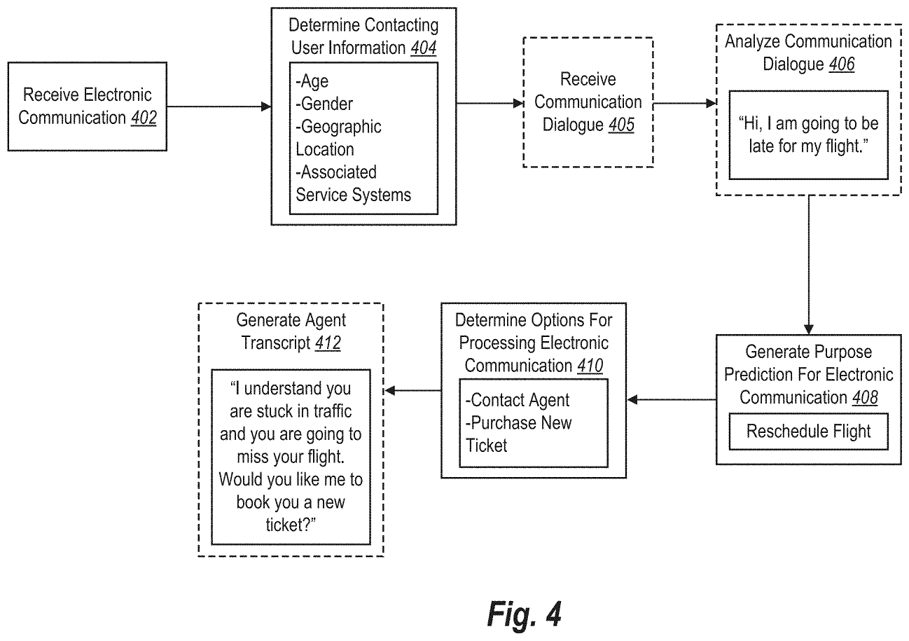

As mentioned, the communication management system 102 receives an electronic communication from a contacting user device 110 and determines options for processing the electronic communication. Indeed, FIG. 4 illustrates a series of acts whereby the communication management system 102 determines options for processing an electronic communication.

As illustrated in FIG. 4, the communication management system 102 performs an act 402 to receive an electronic communication. For example, the communication management system 102 receives a phone call, a video call, or a digital text-based message. In addition, the communication management system 102 performs an act 404 to determine contacting user information. For example, the communication management system 102 determines contacting user information including, but not necessarily limited to, name, age, gender, geographic location, and associated service systems corresponding to the contacting user.

In some embodiments, the communication management system 102 determines contacting user information based on metadata associated with the received electronic communication. For example, the communication management system 102 determines a phone number, name, and a user identifier from metadata embedded within or otherwise corresponding to the electronic communication. Additionally, the communication management system 102 determines a geographic location of the contacting user device 110 based on accessing location information from the contacting user device 110.

In these or other embodiments, the communication management system 102 determines contacting user information by accessing a user profile associated with the contacting user. In particular, the communication management system 102 accesses a profile associated with the name, phone number, username, or other identifier of the contacting user. Indeed, the communication management system 102 maintains user profiles associated with contacting users by maintaining information pertaining to service systems associated with the contacting users. Within the user profile, the communication management system 102 accesses information about the service systems that are relevant to the contacting user. For example, the communication management system 102 determines which service systems have accounts registered with the contacting user and/or which service systems the contacting user otherwise utilizes. Based on determining which service systems are relevant, the communication management system 102 thereby determines which contextual information is pertinent to the contacting user—i.e., the contextual information from the relevant service systems.

As illustrated in FIG. 4, in some embodiments the communication management system 102 further performs an act 405 to receive communication dialogue. In particular, the communication management system 102 receives, obtains, extracts, converts, or otherwise accesses communication dialogue from the received electronic communication. For example, in cases where the communication management system 102 receives an electronic communication in the form of phone call or a video call, the communication management system 102 converts verbally spoken words into digital text. In cases where the communication management system 102 receives an electronic communication in the form of digital text, the communication management system 102 utilizes the digital text as communication dialogue.

As further shown, in some embodiments the communication management system 102 performs an act 406 to analyze the communication dialogue. In particular, the communication management system 102 analyzes the communication dialogue to determine a topic of the electronic communication. Indeed, in many cases the contacting user will express a desire to accomplish a particular purpose or express concern over a particular problem feature. Thus, by determining the topic of the electronic communication by analyzing the communication dialogue, the communication management system 102 determines more precisely the purpose or reason for the contacting user communicating with the communication management system 102. In the example from FIG. 4, the communication management system 102 analyzes the communication dialogue, “Hi, I am going to be late for my flight.”

For example, the communication management system 102 utilizes natural language processing techniques to determine the various parts of the speech of the communication dialogue. Indeed, the communication management system 102 determines that the communication dialogue includes the pronoun “I” as well as the adjective “late” and the noun “flight.” Based on these parts of speech, among others, the communication management system 102 determines that the topic of the communication dialogue indicates that the contacting user is late for a flight.

In other examples, the communication management system 102 can analyze more complicated communication dialogue to simplify complex statements from a contacting user into specific topics. For instance, the communication management system 102 can analyze a communication dialogue such as, “I just bought this dishwasher last week, and now it won't work. I have no idea what the problem is because it was working before, but now I don't even see any lights or anything when I push buttons. It's like no power is getting to the machine,” and the communication management system 102 can determine a topic to be a broken dishwasher.

As illustrated in FIG. 4, the communication management system 102 further performs an act 408 to generate a purpose prediction for the electronic communication. More specifically, the communication management system 102 determines a purpose for why the contacting user would contact the communication management system based on the contacting user information, contextual information, and/or communication dialogue. For example, the communication management system determines correlations between the topic of the communication dialogue, the contacting user information, and/or the contextual information.

To illustrate, in some embodiments, the communication management system 102 generates a purpose prediction based on an identified problem feature (as identified from contextual information). For example, the communication management system 102 determines that the purpose of the contacting user contacting the communication management system 102 is to resolve the problem feature. Alternatively, the communication management system 102 generates a purpose prediction based on contextual information together with contacting user information. For example, the communication management system 102 determines that the contacting user is at a geographic location (as determined from contacting user information) near a location associated with a problem feature (as determined from contextual information). In the same or other embodiments, the communication management system 102 generates a purpose prediction based on contextual information, contacting user information, and communication dialogue. For example, the communication management system 102 determines that the contacting user purchased a product (as determined from contacting user information) that has recently been recalled (as determined from contextual information) and that the user wants to return the product (as determined from communication dialogue).

From the example in FIG. 4, the communication management system 102 generates a purpose prediction to reschedule a flight. Indeed, the communication management system 102 generates the purpose prediction based on one or more of contacting user information, contextual information, and/or communication dialogue indicating that the contacting user wishes to reschedule a flight because they are going to be late.

Additionally, the communication management system 102 performs an act 410 to determine options for processing the electronic communication. In particular, the communication management system 102 determines one or more actions to overcome a problem feature. In some cases, the communication management system 102 determines options to automatically perform one or more actions (e.g., purchasing a new ticket) to help the contacting user overcome the problem feature without involving any third parties (e.g., agent users or service systems). In other cases, the communication management system 102 determines an option to include contacting an agent user to help the contacting user overcome the problem feature. For example, the communication management system 102 provides information such as a purpose prediction and contacting user information to an agent user so that the agent user can more quickly assist the contacting user without needing an explanation of the issue.

As shown, in some embodiments where the communication management system 102 contacts an agent user to assist the contacting user, the communication management system 102 further performs an act 412 to generate an agent transcript. Particularly, the communication management system 102 generates dialogue that is relevant to the contacting user's situation and that the agent user can use to help the contacting user. Indeed, the communication management system 102 generates an agent transcript based on the contextual information, the contacting user information, and or the purpose prediction. From the example in FIG. 4, to help the contacting user more quickly resolve the issue of needing to purchase a new ticket due to bad traffic, the communication management system 102 generates an agent transcript such as, “I understand you are stuck in traffic and you are going to miss your flight. Would you like me to book you a new ticket?”

To generate an agent transcript, the communication management system 102 utilizes one or more techniques or methods to generate text-based responses for the electronic communication. For example, the communication management system 102 can utilize an application programming interface (“API”) and/or a machine learning technique (e.g., a neural network) to generate responses that are relevant to electronic communications. For example, in some embodiments, the communication management system 102 trains a machine learning model to generate sentences based on the contacting user information, the contextual information, and/or the communication dialogue. The communication management system 102 thus generates agent transcripts using terms that are related to the problem feature of the contacting user and that are similar to (e.g., match) terms from the communication dialogue of the contacting user. In embodiments where the communication management system 102 interacts with the contacting user device 110 using phone calls or video calls, the communication management system 102 further converts the text-based responses to audio responses and provides the audio responses to the contacting user device 110 for the contacting user to hear.

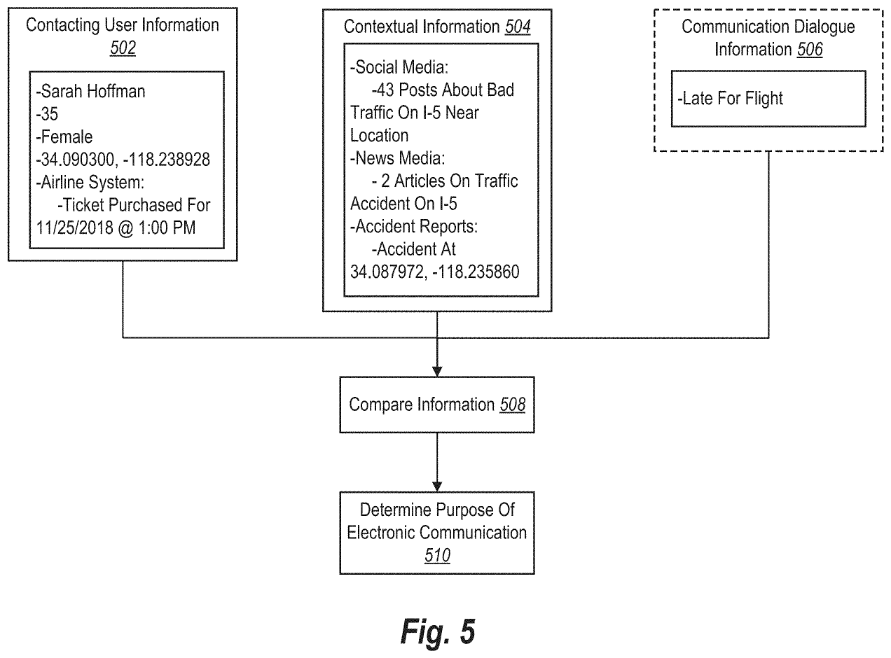

As mentioned above, the communication management system 102 generates a purpose prediction for an electronic communication. FIG. 5 illustrates an example flow for generating a purpose prediction. Indeed, as shown in FIG. 5, the communication management system 102 utilizes the contacting user information 502 and the contextual information 504 to determine a purpose of the electronic communication. In some embodiments, the communication management system 102 also (or alternatively) utilizes communication dialogue information 506 to generate a purpose prediction.

As illustrated in FIG. 5, the communication management system 102 utilizes contacting user information 502 to generate a purpose prediction. For example, the communication management system 102 determines contacting user information 502 as described above, including (but not necessarily limited to) a name of the contacting user, an age of the contacting user, a gender of the contacting user, a geographic location of the contacting user device 110 associated with the contacting user, and information pertaining to service systems associated with the contacting user. As shown in FIG. 5, the communication management system 102 determines contacting user information 502 such as a name of “Sarah Hoffman,” an age of 35, a gender of female, a geographic location given by the coordinates 34.090300, −118.238928, an airline system associated with the contacting user, and a ticket that the contacting user has purchased for Nov. 25, 2018 at 1:00 PM.

As also illustrated in FIG. 5, the communication management system 102 determines contextual information associated with one or more service systems. As shown in FIG. 5, upon receiving an electronic communication, the communication management system 102 triggers determination of contextual information that relates to the electronic communication. For example, the communication management system 102 monitors various service systems to detect or determine various problem features pertaining to the contacting user information 502.

As shown, the communication management system 102 utilizes the geographic location of the contacting user device 110 as a basis for determining contextual information 504. Indeed, the communication management system 102 determines a correlation between the location of the contacting user device 110 and various other contextual information 504 such as social media posts, news reports, and emergency system reports. As illustrated, the communication management system 102 determines contextual information 504 relating to the contacting user information 502 (e.g., the geographic location) that includes 43 social media posts about traffic on I-5 near (e.g., within a threshold distance of) the location of the contacting user device 110, 2 news articles on a traffic accident on I-5 within a threshold distance (e.g., 1 mile, 5 miles, 10 miles, or 50 miles) of the location of the contacting user device 110, and an accident report from an emergency reporting system at a particular geographic location (34.087972, −118.235860) along I-5 in the direction the contacting user device 110 is traveling.

In some embodiments, the communication management system 102 further determines communication dialogue information 506. In particular, the communication management system 102 analyzes the communication dialogue of the electronic communication to determine a topic of the electronic communication. For example, the communication management system 102 determines the topic of the communication dialogue “Hi, I am going to be late for my flight” to be an indication that the contacting user is late for flight—e.g., “late for flight,” as shown in FIG. 5.

As illustrated in FIG. 5, the communication management system 102 performs an act 508 to compare information. More specifically, the communication management system 102 compares the contacting user information 502, the contextual information 504, and/or the communication dialogue information 506. In some embodiments, the communication management system 102 compares the contacting user information 502 with the contextual information 504 to determine correlations between any of the information therein. For example, the communication management system 102 determines correlations between a geographic location of the contacting user device 110 and the geographic location of a traffic accident along I-5 near Los Angeles. As another example, the communication management system 102 determines a correlation between a product purchased by the contacting user and a product that has been issued for recall by the manufacturer. As yet another example, the communication management system 102 determines a correlation between a canceled flight of the contacting user and a storm reported by a weather service.

In some embodiments, the communication management system 102 further compares the communication dialogue information 506. In particular, the communication management system 102 compares the topic of the communication dialogue with known information about the contacting user. For example, the communication management system 102 compares the dialogue indication that the contacting user is late for a flight with contacting user information indicating that the contacting user has a particular flight booked out of Los Angeles International Airport on Nov. 25, 2018 for 1:00 PM with a particular airline, flight number, and destination. Additionally (or alternatively), the communication management system 102 compares the communication dialogue information 506 with the contextual information 504. For example, the communication management system 102 compares the topic that indicates that the contacting user is late for a flight with information indicating a traffic accident along I-5 in a direction toward the airport from the current location of the contacting user device 110.

To compare the information, in some embodiments the communication management system 102 utilizes data tables to store the various types of information (e.g., the contacting user information 502, the contextual information 504, and the communication dialogue information 506). Thus, the communication management system 102 stores individual pieces of information as entries within a table and matches like entries between the tables of the different types of information. For example, the communication management system 102 stores a geographic location of the contacting user device 110 within a contacting user information table and looks up that same location (or locations within a threshold distance or radius) within the contextual information table. In response to identifying a match, the communication management system 102 determines a correlation between the location of the contacting user device 110 and a particular piece of contextual information (e.g., a problem feature).

In other embodiments, to compare the information, the communication management system 102 utilizes a machine learning model such as a neural network. To illustrate, the communication management system 102 trains a neural network to predict a probability or likelihood of contacting user information 502 matching (or corresponding to) contextual information 504. Conversely, the communication management system 102 can train a neural network to predict a probability that contextual information 504 corresponds to contacting user information 502, where, instead of utilizing contacting user information 502 as the input to the neural network, the communication management system 102 utilizes the contextual information 504 as the input.

As further illustrated in FIG. 5, the communication management system 102 performs an act 510 to determine a purpose of the electronic communication. In particular, the communication management system 102 generates the predicted purpose based on the comparison of the contacting user information 502, the contextual information 504, and/or the communication dialogue information 506. For instance, the communication management system 102 extrapolates a conclusion from comparing the information (act 508). In the example of FIG. 5, the communication management system 102 determines that the purpose of the electronic communication is to reschedule a flight.

To determine the purpose of the electronic communication, in some embodiments the communication management system 102 selects a purpose prediction from a set of predefined purposed predictions. For example, the communication management system 102 utilizes a machine learning model such as a neural network to classify the electronic communication as belonging to one of a set of purpose predictions. To illustrate, based on an input dataset (e.g., including contacting user information 502, contextual information 504, and/or communication dialogue information 506) relating to a received electronic communication, the communication management system 102 trains a neural network to generate a probability distribution for the electronic communication applying to a set of purpose predictions, where the different probabilities within the distribution define a likelihood of the electronic communication corresponding to a respective purpose prediction. In some embodiments, the communication management system 102 selects the purpose prediction with the highest probability as the purpose prediction for the electronic communication.

Although not illustrated in FIG. 5, the communication management system 102 can determine and compare different information than the specific examples shown in FIG. 5. Indeed, the communication management system 102 can determine different contacting user information, different contextual information, and/or different communication dialogue information. For example, in situations where the communication management system receives an electronic communication about a faulty or defective product (e.g., a smart appliance or some other product), the communication management system 102 determines contextual information related to the particular product. For instance, the communication management system 102 determines contextual information such as product reviews, social media posts, product recalls, news articles, etc. about products with the same (or similar) name or identification number (e.g., SKU number). In some cases, the communication management system 102 further determines contextual information such as error codes, identification of faulty components, or other reports directly from a smart appliance.

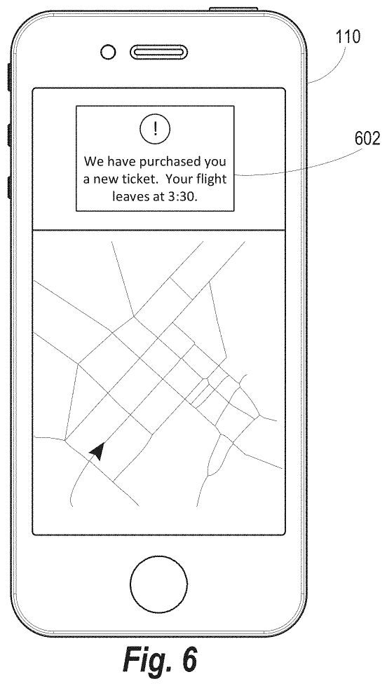

As mentioned, the communication management system 102 determines options for processing a received electronic communication. In some cases, the communication management system 102 further automatically performs an option for processing the electronic communication. FIG. 6 illustrates an example option that the communication management system 102 performs based on a contacting user (e.g., “Sarah Hoffman” from the previous examples) sending an electronic communication about missing a flight due to bad traffic.

As illustrated in FIG. 6, the communication management system 102 automatically generates and provides a notification 602 to the contacting user device 110 associated with the contacting user. In particular, the communication management system 102 determines an option to accomplish a purpose of the electronic communication received from the contacting user device 110 (e.g., as received in act 402 above). For example, to accomplish the purpose of rescheduling a flight (e.g., as determined in act 408 above), the communication management system 102 determines to automatically purchase a new ticket to reschedule the contacting user's flight for a later time. In some embodiments, the communication management system 102 further determines a predicted or estimated amount of time for the contacting user to travel to the airport based on current traffic and/or weather conditions. The communication management system 102 thus purchases a new ticket for a later time that allows the contacting user to travel to the airport and board the flight on time. In addition, the communication management system 102 generates and provides the notification 602 to the contacting user device 110 to inform the contacting user that the purpose prediction has been accomplished and that the contacting user's issue has been resolved.

The communication management system 102 can automatically perform options other than the option shown in FIG. 6. For example, in cases where the contacting user desires to replace a defective product, the communication management system 102 automatically purchases a new product with the same identification number and provides a notification to the contacting user device 110 accordingly. In cases where the contacting user desires to know how long it will be until power or internet service is restored, the communication management system 102 automatically obtains a time estimate from the power distribution system or the internet service provider system and provides a notification indicating the time estimate to the contacting user device 110. Additionally (or alternatively), in cases where the contacting user desires to schedule a home repair (or other service), the communication management system 102 automatically contacts a repair service (or other service) to schedule a repair and provides a notification to the contacting user device 110 of a set appointment. Additional or alternative scenarios are also possible.

As mentioned above, in some cases the communication management system 102 connects a contacting user device 110 with an agent device 106 as an option for processing a received electronic communication. Indeed, FIG. 7 illustrates an example flow whereby the communication management system 102 connects the contacting user device 110 with the agent device 106. As shown, upon determining an option for processing a received electronic communication, the communication management system 102 executes the option by perform an act 702 to connect the contacting user device 110 and the agent device 106. By connecting the contacting user device 110 and the agent device 106, the communication management system 102 facilitates communication between the contacting user and the agent user via digital text-based conversation, video chat, and/or phone call.

As illustrated, the communication management system 102 generates and provides an agent interface 704 for display by the agent device 106. In particular, the communication management system 102 generates an agent interface 704 that includes a contacting user communication element 706. For example, the contacting user communication element 706 includes selectable options to manage a correspondence with the contacting user, including options to transfer a call, hang up, conference call with another agent user, mute, place on hold, pause, and change to a different type of communication (e.g., switch from video chat to phone call or vice-versa).

In addition, the contacting user communication element 706 includes various contacting user information, contextual information, and/or purpose predictions that the communication management system 102 generates and provides to the agent device 106. For example, the communication management system 102 provides information such as the contacting user's name (“Sarah Hoffman”), phone number, time of communication, and various other information such as the generated purpose prediction (“Needs help rebooking a flight”) and a determined status of the contacting user (“Stuck in traffic near LAX”). By providing this information to the agent device 106, the communication management system 102 more quickly and accurately processes the electronic communication received from the contacting user device 110.

Indeed, the communication management system 102 enables the agent user to more effectively help the contacting user at the outset of the conversation without requiring wasteful back-and-forth to get the agent user up to speed on the contacting user's situation. To further help the agent user, the communication management system 102 further generates an agent transcript 708. For example, the communication management system 102 generates a dialogue that is directly relevant to the circumstances of the contacting user and provides the dialogue to the agent device 106 for the agent user to read. As shown, the communication management system 102 provides the agent transcript 708, “I understand you are stuck in traffic and you are going to miss your flight. Would you like me to book you a new ticket?” Thus, rather than merely connecting the agent user with the contacting user without providing any context into the contacting user's situation, the communication management system 102 informs the agent user of relevant information and initiates a productive, problem-solving-based dialogue from the beginning of the conversation.

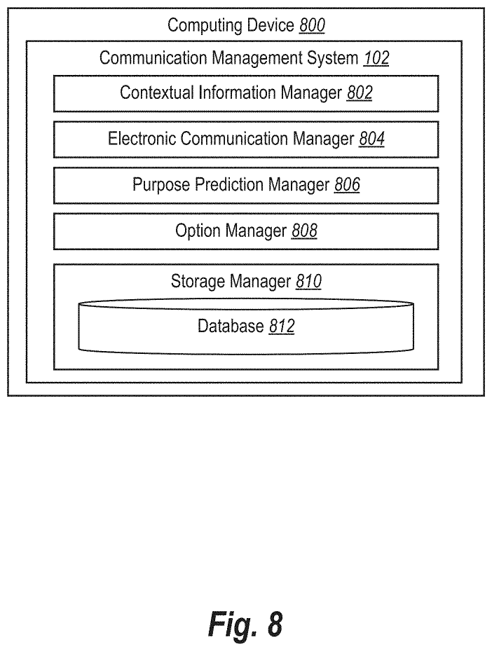

Looking now to FIG. 8, additional detail will be provided regarding components and capabilities of the communication management system 102. Specifically, FIG. 8 illustrates an example schematic diagram of the communication management system 102 on an example computing device 800 (e.g., one or more of the contacting user device 110, the agent device 106, and/or the server(s) 104). As shown in FIG. 8, the communication management system 102 may include a contextual information manager 802, an electronic communication manager 804, a purpose prediction manager 806, an option manager 808, and a storage manager 810.

As just mentioned, the communication management system 102 includes a contextual information manager 802. The contextual information manager 802 manages, obtains, gathers, collects, identifies, determines, or generates contextual information. For example, the contextual information manager 802 communicates with or monitors one or more service systems to determine contextual information. Based on the contextual information, the contextual information manager 802 further determines, identifies, generates, or extrapolates a problem feature associated with a service system.

As also mentioned, the communication management system 102 includes an electronic communication manager 804. The electronic communication manager 804 manages, receives, or accesses an electronic communication. For example, the electronic communication manager 804 receives an electronic communication from a contacting user device 110. In addition, the electronic communication manager determines, identifies, or generates contacting user information based on receiving an electronic communication. For example, the electronic communication manager 804 determines a geographic location, name, phone number, and associated service systems for a contacting user. Further, the electronic communication determines, extracts, or generates a communication dialogue from an electronic communication.

In addition, the communication management system 102 includes purpose prediction manager 806. The purpose prediction manager 806 manages, generates, determines, or predicts purpose predictions based on contacting user, contextual information, and/or communication dialogue. For example, the purpose prediction manager 806 communicates with the contextual information manager 802 and the electronic communication manager 804 to generate a prediction of a purpose corresponding to a received electronic communication.

As shown, the communication management system 102 includes an option manager 808. The option manager 808 manages, determines, generates, or identifies options for processing electronic communications. In particular, the option manager 808 communicates with the contextual information manager 802, the electronic communication manager, and/or the purpose prediction manager 806 to determine an option for accomplishing a predicted purpose of a received electronic communication. Additionally, in some cases, the option manager 808 automatically executes a determined option for processing an electronic communication.

As further shown, the communication management system 102 includes a storage manager 810. The storage manager 810 communicates with various other components of the communication management system 102 such as the contextual information manager 802, the electronic communication manager 804, the purpose prediction manager 806, and the option manager 808 to store various information within the database 812. For example, storage manager 810 generates, manages, and maintains profiles for contacting users based on storing contextual information, contacting user information, and/or communication dialogue within the database 812.

In one or more embodiments, each of the components of the communication management system 102 are in communication with one another using any suitable communication technologies. Additionally, the components of the communication management system 102 can be in communication with one or more other devices including one or more client devices described above. It will be recognized that although the components of the communication management system 102 are shown to be separate in FIG. 8, any of the subcomponents may be combined into fewer components, such as into a single component, or divided into more components as may serve a particular implementation. Furthermore, although the components of FIG. 8 are described in connection with the communication management system 102, at least some of the components for performing operations in conjunction with the communication management system 102 described herein may be implemented on other devices within the environment.

The components of the communication management system 102 can include software, hardware, or both. For example, the components of the communication management system 102 can include one or more instructions stored on a computer-readable storage medium and executable by processors of one or more computing devices (e.g., the computing device 800). When executed by the one or more processors, the computer-executable instructions of the communication management system 102 can cause the computing device 800 to perform the methods described herein. Alternatively, the components of the communication management system 102 can comprise hardware, such as a special purpose processing device to perform a certain function or group of functions. Additionally or alternatively, the components of the communication management system 102 can include a combination of computer-executable instructions and hardware.

Furthermore, the components of the communication management system 102 performing the functions described herein may, for example, be implemented as part of a stand-alone application, as a module of an application, as a plug-in for applications including content management applications, as a library function or functions that may be called by other applications, and/or as a cloud-computing model. Thus, the components of the communication management system 102 may be implemented as part of a stand-alone application on a personal computing device or a mobile device.

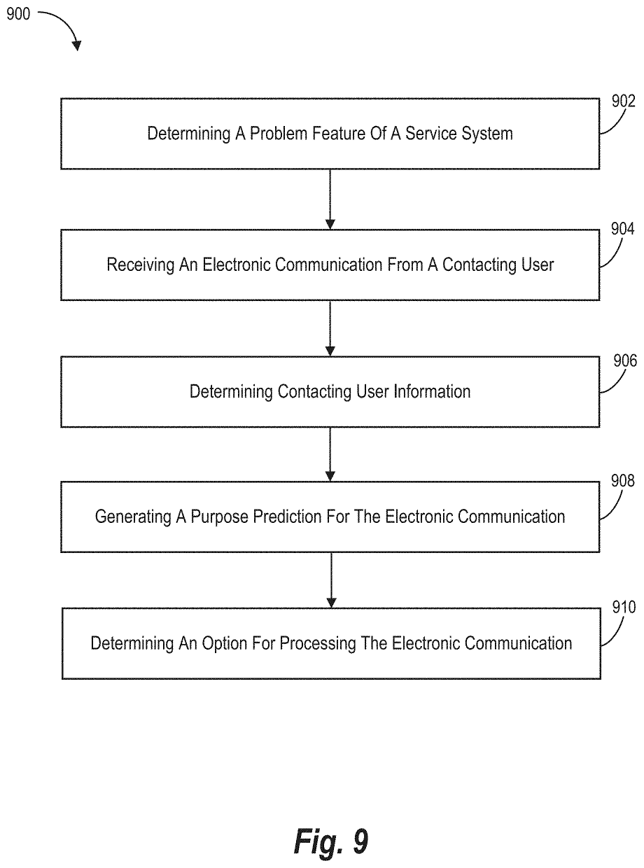

FIGS. 1-8, the corresponding text, and the examples provide a number of different systems, methods, and non-transitory computer readable media for generating purpose predictions and corresponding options for processing electronic communications. In addition to the foregoing, embodiments can also be described in terms of flowcharts comprising acts for accomplishing a particular result. For example, FIG. 9 illustrates a flowchart of an example sequence of acts in accordance with one or more embodiments.

While FIG. 9 illustrates acts according to one embodiment, alternative embodiments may omit, add to, reorder, and/or modify any of the acts shown in FIG. 9. The acts of FIG. 9 can be performed as part of a method. Alternatively, a non-transitory computer readable medium can comprise instructions, that when executed by one or more processors, cause a computing device to perform the acts of FIG. 9. In still further embodiments, a system can perform the acts of FIG. 9. Additionally, the acts described herein may be repeated or performed in parallel with one another or in parallel with different instances of the same or other similar acts.

FIG. 9 illustrates an example series of acts 900 of determining an option for processing an electronic communication. The series of acts 900 can include an act 902 of determining a problem feature of a service system. In particular, the act 902 can involve determining, based on contextual information associated with a service system, a problem feature corresponding to the service system. The act 902 can involve receiving an indication of the problem feature from the service system. The act 902 can also (or alternatively) involve analyzing the contextual information associated with the service system and defining the problem feature based on the analysis of the contextual information. In addition, the act 902 can involve determining a correlation between a geographic location and the contextual information. A service system can include one or more of a social networking system, an airline system, a traffic information system, an internet service provider system, a weather information system, or a news media system.

As shown, the series of acts 900 can include an act 904 of receiving an electronic communication from a contacting user. In particular, the act 904 can involve receiving, from a client device associated with a contacting user, an electronic communication corresponding to the problem feature. Based on the electronic communication, the series of acts 900 can include an act of identifying communication dialogue associated with the electronic communication.

In addition, the series of acts 900 can include an act 906 of determining contacting user information. In particular, the act 906 can involve determining, in response to the electronic communication, contacting user information associated with the contacting user. The series of acts 900 can also include an act of determining, based on one or more of the contacting user information or the communication dialogue, a topic corresponding to the electronic communication. Contacting user information can include one or more of a time associated with the electronic communication, a location associated with the client device associated with the contacting user, profile information associated with the contacting user, or service system information associated with the contacting user.

Further, the series of acts 900 can include an act 908 of generating a purpose prediction for the electronic communication. In particular, the act 908 can involve generating, based on the problem feature and the contacting user information, a purpose prediction for the electronic communication. The act 908 can involve generating the purpose prediction further based on the communication dialogue associated with the electronic communication. Additionally (or alternatively), the act 908 can involve generating the purpose prediction further based on the topic corresponding to the electronic communication. Further, the act 908 can involve determining a correlation between the problem feature and the contacting user information.

As illustrated, the series of acts can further include an act 910 of determining an option for processing the electronic communication. In particular, the act 910 can involve determining an option for processing the electronic communication based on the purpose prediction.

Although not illustrated in FIG. 9, the series of acts 900 can further include an act of automatically executing the option for processing the electronic communication. The option for processing the electronic communication can include identifying communication dialogue associated with the electronic communication, generating, based on the communication dialogue and the purpose prediction, an agent transcript comprising one or more agent responses to the electronic communication, and providing the contacting user information, the purpose prediction, and the agent transcript to a client device associated with an agent user. In addition, the series of acts 900 can include an act of connecting the client device associated with the contacting user with the client device associated with the agent user to facilitate communication between the contacting user and the agent user.

The series of acts 900 can also include an act of identifying contextual information associated with a second service system. In addition, the series of acts 900 can include an act of determining the problem feature by analyzing the contextual information associated with the service system and the contextual information associated with the second service system and defining the problem feature based on the analysis of the contextual information associated with the service system and the contextual information associated with the second service system.

Embodiments of the present disclosure may comprise or utilize a special purpose or general-purpose computer including computer hardware, such as, for example, one or more processors and system memory, as discussed in greater detail below. Embodiments within the scope of the present disclosure also include physical and other computer-readable media for carrying or storing computer-executable instructions and/or data structures. In particular, one or more of the processes described herein may be implemented at least in part as instructions embodied in a non-transitory computer-readable medium and executable by one or more computing devices (e.g., any of the media content access devices described herein). In general, a processor (e.g., a microprocessor) receives instructions, from a non-transitory computer-readable medium, (e.g., a memory, etc.), and executes those instructions, thereby performing one or more processes, including one or more of the processes described herein.

Computer-readable media can be any available media that can be accessed by a general purpose or special purpose computer system. Computer-readable media that store computer-executable instructions are non-transitory computer-readable storage media (devices). Computer-readable media that carry computer-executable instructions are transmission media. Thus, by way of example, and not limitation, embodiments of the disclosure can comprise at least two distinctly different kinds of computer-readable media: non-transitory computer-readable storage media (devices) and transmission media.

Non-transitory computer-readable storage media (devices) includes RAM, ROM, EEPROM, CD-ROM, solid state drives (“SSDs”) (e.g., based on RAM), Flash memory, phase-change memory (“PCM”), other types of memory, other optical disk storage, magnetic disk storage or other magnetic storage devices, or any other medium which can be used to store desired program code means in the form of computer-executable instructions or data structures and which can be accessed by a general purpose or special purpose computer.

A “network” is defined as one or more data links that enable the transport of electronic data between computer systems and/or modules and/or other electronic devices. When information is transferred or provided over a network or another communications connection (either hardwired, wireless, or a combination of hardwired or wireless) to a computer, the computer properly views the connection as a transmission medium. Transmissions media can include a network and/or data links which can be used to carry desired program code means in the form of computer-executable instructions or data structures and which can be accessed by a general purpose or special purpose computer. Combinations of the above should also be included within the scope of computer-readable media.

Further, upon reaching various computer system components, program code means in the form of computer-executable instructions or data structures can be transferred automatically from transmission media to non-transitory computer-readable storage media (devices) (or vice versa). For example, computer-executable instructions or data structures received over a network or data link can be buffered in RAM within a network interface module (e.g., a “NIC”), and then eventually transferred to computer system RAM and/or to less volatile computer storage media (devices) at a computer system. Thus, it should be understood that non-transitory computer-readable storage media (devices) can be included in computer system components that also (or even primarily) utilize transmission media.

Computer-executable instructions comprise, for example, instructions and data which, when executed at a processor, cause a general-purpose computer, special purpose computer, or special purpose processing device to perform a certain function or group of functions. In some embodiments, computer-executable instructions are executed on a general-purpose computer to turn the general-purpose computer into a special purpose computer implementing elements of the disclosure. The computer executable instructions may be, for example, binaries, intermediate format instructions such as assembly language, or even source code. Although the subject matter has been described in language specific to structural features and/or methodological acts, it is to be understood that the subject matter defined in the appended claims is not necessarily limited to the described features or acts described above. Rather, the described features and acts are disclosed as example forms of implementing the claims.

Those skilled in the art will appreciate that the disclosure may be practiced in network computing environments with many types of computer system configurations, including, personal computers, desktop computers, laptop computers, message processors, hand-held devices, multi-processor systems, microprocessor-based or programmable consumer electronics, network PCs, minicomputers, mainframe computers, mobile telephones, PDAs, tablets, pagers, routers, switches, and the like. The disclosure may also be practiced in distributed system environments where local and remote computer systems, which are linked (either by hardwired data links, wireless data links, or by a combination of hardwired and wireless data links) through a network, both perform tasks. In a distributed system environment, program modules may be located in both local and remote memory storage devices.

Embodiments of the present disclosure can also be implemented in cloud computing environments. In this description, “cloud computing” is defined as a model for enabling on-demand network access to a shared pool of configurable computing resources. For example, cloud computing can be employed in the marketplace to offer ubiquitous and convenient on-demand access to the shared pool of configurable computing resources. The shared pool of configurable computing resources can be rapidly provisioned via virtualization and released with low management effort or service provider interaction, and then scaled accordingly.

A cloud-computing model can be composed of various characteristics such as, for example, on-demand self-service, broad network access, resource pooling, rapid elasticity, measured service, and so forth. A cloud-computing model can also expose various service models, such as, for example, Software as a Service (“SaaS”), Platform as a Service (“PaaS”), and Infrastructure as a Service (“IaaS”). A cloud-computing model can also be deployed using different deployment models such as private cloud, community cloud, public cloud, hybrid cloud, and so forth. In this description and in the claims, a “cloud-computing environment” is an environment in which cloud computing is employed.

FIG. 10 illustrates, in block diagram form, an example computing device 1000 (e.g., the computing device 1000, the contacting user device 110, the agent device 106, and/or the server(s) 104) that may be configured to perform one or more of the processes described above. One will appreciate that the communication management system 102 can comprise implementations of the computing device 1000. As shown by FIG. 10, the computing device can comprise a processor 1002, memory 1004, a storage device 1006, an I/O interface 1008, and a communication interface 1010. Furthermore, the computing device 1000 can include an input device such as a touchscreen, mouse, keyboard, etc. In certain embodiments, the computing device 1000 can include fewer or more components than those shown in FIG. 10. Components of computing device 1000 shown in FIG. 10 will now be described in additional detail.

In particular embodiments, processor(s) 1002 includes hardware for executing instructions, such as those making up a computer program. As an example, and not by way of limitation, to execute instructions, processor(s) 1002 may retrieve (or fetch) the instructions from an internal register, an internal cache, memory 1004, or a storage device 1006 and decode and execute them.

The computing device 1000 includes memory 1004, which is coupled to the processor(s) 1002. The memory 1004 may be used for storing data, metadata, and programs for execution by the processor(s). The memory 1004 may include one or more of volatile and non-volatile memories, such as Random-Access Memory (“RAM”), Read Only Memory (“ROM”), a solid-state disk (“SSD”), Flash, Phase Change Memory (“PCM”), or other types of data storage. The memory 1004 may be internal or distributed memory.

The computing device 1000 includes a storage device 1006 includes storage for storing data or instructions. As an example, and not by way of limitation, storage device 1006 can comprise a non-transitory storage medium described above. The storage device 1006 may include a hard disk drive (HDD), flash memory, a Universal Serial Bus (USB) drive or a combination of these or other storage devices.

The computing device 1000 also includes one or more input or output (“I/O”) devices/interfaces 1008, which are provided to allow a user to provide input to (such as user strokes), receive output from, and otherwise transfer data to and from the computing device 1000. These I/O devices/interfaces 1008 may include a mouse, keypad or a keyboard, a touch screen, camera, optical scanner, network interface, modem, other known I/O devices or a combination of such I/O devices/interfaces 1008. The touch screen may be activated with a writing device or a finger.

The I/O devices/interfaces 1008 may include one or more devices for presenting output to a user, including, but not limited to, a graphics engine, a display (e.g., a display screen), one or more output drivers (e.g., display drivers), one or more audio speakers, and one or more audio drivers. In certain embodiments, devices/interfaces 1008 is configured to provide graphical data to a display for presentation to a user. The graphical data may be representative of one or more graphical user interfaces and/or any other graphical content as may serve a particular implementation.

The computing device 1000 can further include a communication interface 1010. The communication interface 1010 can include hardware, software, or both. The communication interface 1010 can provide one or more interfaces for communication (such as, for example, packet-based communication) between the computing device and one or more other computing devices 1000 or one or more networks. As an example, and not by way of limitation, communication interface 1010 may include a network interface controller (NIC) or network adapter for communicating with an Ethernet or other wire-based network or a wireless NIC (WNIC) or wireless adapter for communicating with a wireless network, such as a WI-FI. The computing device 1000 can further include a bus 1012. The bus 1012 can comprise hardware, software, or both that couples components of computing device 1000 to each other.

In the foregoing specification, the invention has been described with reference to specific example embodiments thereof. Various embodiments and aspects of the invention(s) are described with reference to details discussed herein, and the accompanying drawings illustrate the various embodiments. The description above and drawings are illustrative of the invention and are not to be construed as limiting the invention. Numerous specific details are described to provide a thorough understanding of various embodiments of the present invention.

The present invention may be embodied in other specific forms without departing from its spirit or essential characteristics. The described embodiments are to be considered in all respects only as illustrative and not restrictive. For example, the methods described herein may be performed with less or more steps/acts or the steps/acts may be performed in differing orders. Additionally, the steps/acts described herein may be repeated or performed in parallel with one another or in parallel with different instances of the same or similar steps/acts. The scope of the invention is, therefore, indicated by the appended claims rather than by the foregoing description. All changes that come within the meaning and range of equivalency of the claims are to be embraced within their scope.

FIG. 11 illustrates an example network environment 1100 of a communication management system. Network environment 1100 includes a contacting user device 1102 (e.g., the contacting user device 110), a communication management system 102, a third-party system 1106, and an agent device 1108 connected to each other by a network 1104. Although FIG. 11 illustrates a particular arrangement of the contacting user device 1102, the communication management system 102, the agent device 1108, the third-party system 1106, and network 1104, this disclosure contemplates any suitable arrangement of the contacting user device 1102, the communication management system 102, the third-party system 1106, the agent device 1108, and the network 1104. As an example, and not by way of limitation, two or more of the contacting user device 1102, the communication management system 102, the agent device 1108, and the third-party system 1106 may be connected to each other directly, bypassing network 1104. As another example, two or more of the contacting user device 1102, the communication management system 102, the agent device 1108, and the third-party system 1106 may be physically or logically co-located with each other in whole or in part. Moreover, although FIG. 11 illustrates a particular number of contacting user devices 1102, communication management systems 102, agent devices 1108, third-party systems 1106, and networks 1104, this disclosure contemplates any suitable number of contacting user devices 1102, communication management systems 102, agent devices 1108, third-party systems 1106, and networks 1104. As an example, and not by way of limitation, network environment 1100 may include multiple contacting user devices 1102, communication management systems 102, agent devices 1108, third-party systems 1106, and networks 1104.

This disclosure contemplates any suitable network 1104. As an example, and not by way of limitation, one or more portions of the network 1104 may include an ad hoc network, an intranet, an extranet, a virtual private network (VPN), a local area network (LAN), a wireless LAN (WLAN), a wide area network (WAN), a wireless WAN (WWAN), a metropolitan area network (MAN), a portion of the Internet, a portion of the Public Switched Telephone Network (PSTN), a cellular telephone network, or a combination of two or more of these. The network 1104 may include one or more networks 1104.

Links may connect the contacting user device 1102, the communication management system 102, the agent device 1108, and the third-party system 1106 to communication network 1104 or to each other. This disclosure contemplates any suitable links. In particular embodiments, one or more links include one or more wireline (such as for example Digital Subscriber Line (DSL) or Data Over Cable Service Interface Specification (DOCSIS)), wireless (such as for example Wi-Fi or Worldwide Interoperability for Microwave Access (WiMAX)), or optical (such as for example Synchronous Optical Network (SONET) or Synchronous Digital Hierarchy (SDH)) links. In particular embodiments, one or more links each include an ad hoc network, an intranet, an extranet, a VPN, a LAN, a WLAN, a WAN, a WWAN, a MAN, a portion of the Internet, a portion of the PSTN, a cellular technology-based network, a satellite communications technology-based network, another link, or a combination of two or more such links. Links need not necessarily be the same throughout network environment 1100. One or more first links may differ in one or more respects from one or more second links.

In particular embodiments, the contacting user device 1102 and/or agent device 1108 may be an electronic device including hardware, software, or embedded logic components or a combination of two or more such components capable of carrying out the appropriate functionalities implemented or supported by the contacting user device 1102 and/or agent device 1108. As an example, and not by way of limitation, a contacting user device 1102 or agent device 1108 may include any of the computing devices discussed above in relation to FIG. 10. A contacting user device 1102 may enable a network user (e.g., a contacting user) at the contacting user device 1102 to access the network 1104. A contacting user device 1102 may enable its user to communicate with other users at other contacting user devices 1102 and/or agent devices 1108. Likewise, an agent device 1108 may enable its user to communicate with contacting user devices 1102, third-party systems 1106, and/or the communication management system 102.

In particular embodiments, the agent device 1108 is part of (e.g., housed within, either entirely or in part) the third-party system 1106. For example, the third-party system 1106 may include a service system which maintains one or more agent users, each associated with a separate agent device 1108. Accordingly, the communication management system 102 provides various functionality, user interfaces, electronic communications, and other information to the agent device 1108 via the third-party system 1106. In other embodiments, the agent device 1108 is not associated with or part of a third-party system 1106. Rather, the agent device 1108 refers to a client device associated directly with the communication management system 102 or a different third-party and that communicates with the communication management system 102 without interaction via the third-party system 1106.

In particular embodiments, the contacting user device 1102 and/or the agent device 1108 may include a web browser, such as MICROSOFT INTERNET EXPLORER, GOOGLE CHROME or MOZILLA FIREFOX, and may have one or more add-ons, plug-ins, or other extensions, such as TOOLBAR or YAHOO TOOLBAR. A user at contacting user device 1102 and/or agent device 1108 may enter a Uniform Resource Locator (URL) or other address directing the web browser to a particular server (such as server, or a server associated with a third-party system 1106), and the web browser may generate a Hyper Text Transfer Protocol (HTTP) request and communicate the HTTP request to server. The server may accept the HTTP request and communicate to the contacting user device 1102 (or the agent device 1108) one or more Hyper Text Markup Language (HTML) files responsive to the HTTP request. The contacting user device 1102 and/or agent device 1108 may render a webpage based on the HTML files from the server for presentation to the user. This disclosure contemplates any suitable webpage files. As an example, and not by way of limitation, webpages may render from HTML files, Extensible Hyper Text Markup Language (XHTML) files, or Extensible Markup Language (XML) files, according to particular needs. Such pages may also execute scripts such as, for example and without limitation, those written in JAVASCRIPT, JAVA, MICROSOFT SILVERLIGHT, combinations of markup language and scripts such as AJAX (Asynchronous JAVASCRIPT and XML), and the like. Herein, reference to a webpage encompasses one or more corresponding webpage files (which a browser may use to render the webpage) and vice versa, where appropriate.

In particular embodiments, the communication management system 102 may be a network-addressable computing system that can host an online communication network. The communication management system 102 may generate, store, receive, and send messaging data, such as, for example, text data, audio data, and video data. The communication management system 102 can further generate, store, receive, and send other data such as user-profile data, location data, or other suitable data related to the online communication network. The communication management system 102 may be accessed by the other components of network environment 1100 either directly or via network 1104. In particular embodiments, the communication management system 102 may include one or more servers. Each server may be a unitary server or a distributed server spanning multiple computers or multiple datacenters. Servers may be of various types, such as, for example and without limitation, a web server, a communication server, a news server, a mail server, a message server, an advertising server, a file server, an application server, an exchange server, a database server, a proxy server, or another server suitable for performing functions or processes described herein, or any combination thereof. In particular embodiments, each server may include hardware, software, or embedded logic components or a combination of two or more such components for carrying out the appropriate functionalities implemented or supported by server.

In particular embodiments, the communication management system 102 may include one or more data stores. Data stores may be used to store various types of information. In particular embodiments, the information stored in data stores may be organized according to specific data structures. In particular embodiments, each data store may be a relational, columnar, correlation, or other suitable database. Although this disclosure describes or illustrates particular types of databases, this disclosure contemplates any suitable types of databases. Particular embodiments may provide interfaces that enable a contacting user device 1102, a communication management system 102, an agent device 1108, or a third-party system 1106 to manage, retrieve, modify, add, or delete, the information stored in data store.

In particular embodiments, the communication management system 102 may store one or more correspondences in one or more data stores. In particular embodiments, a correspondence may include electronic messages—which may include digital audio, digital video, and/or digital text (e.g., as received in an electronic message or as transcribed from digital audio). The communication management system 102 may provide users (e.g., contacting users) of the online communication network the ability to communicate and interact with other users (e.g., agent users). In particular embodiments, agent users may join the online communication network via the communication management system 102, and the communication management system 102 may maintain connects for the agent users, including current and historical information relating to contacting users with whom the agent users interact.

In particular embodiments, the communication management system 102 may provide agent users with the ability to take actions on various types of items or objects, supported by communication management system 102. As an example, and not by way of limitation, the items and objects may include groups or individual contacting users communicating with the communication management system 102, computer-based applications that a user may use, transactions that allow agent users to buy, return, or sell items or services, indications that allow agent users to report events, or other interactions with various operations that an agent user may perform to assist a contacting user.

In particular embodiments, communication management system 102 may be capable of linking a variety of entities. As an example, and not by way of limitation, communication management system 102 may enable users such as contacting users and agent users to interact with each other as well as receive content from third-party systems 1106 or other entities, or to allow users to interact with these entities through an application programming interfaces (API) or other communication channels.

In particular embodiments, a third-party system 1106 may include one or more types of servers, one or more data stores, one or more interfaces, including but not limited to APIs, one or more web services, one or more content sources, one or more networks, or any other suitable components, e.g., that servers may communicate with. A third-party system 1106 may be operated by a different entity from an entity operating communication management system 102. In particular embodiments, however, communication management system 102 and third-party systems 1106 may operate in conjunction with each other to provide communication services to users of communication management system 102 or third-party systems 1106. In this sense, communication management system 102 may provide a platform, or backbone, which other systems, such as third-party systems 1106, may use to provide communication services and functionality to users across the Internet or other network.

In particular embodiments, a third-party system 1106 may include a third-party service system. A third-party content service system may include one or more sources of products or services that are used by contacting user. As an example, and not by way of limitation, a service system can include a traffic monitoring system, a social networking system, an emergency reporting system, a home repair system, a weather monitoring system, an internet service provider system, an airline system, a transportation provider system, a news media system, a travel accommodation system, an electronic smart appliance distribution or monitoring system, or a power distribution or monitoring system.

In particular embodiments, the communication management system 102 may include a variety of servers, sub-systems, programs, modules, logs, and data stores. In particular embodiments, the communication management system 102 may include one or more of the following: a web server, action logger, API-request server, notification controller, action log, inference module, search module, advertisement-targeting module, user-interface module, user-profile store, third-party content store, or location store. The communication management system 102 may also include suitable components such as network interfaces, security mechanisms, load balancers, failover servers, management-and-network-operations consoles, other suitable components, or any suitable combination thereof. In particular embodiments, the communication management system 102 may include one or more user-profile stores for storing user profiles (e.g., for contacting users). A user profile may include, for example, contacting user information, biographic information, demographic information, behavioral information, social information, or other types of descriptive information, such as work experience, educational history, hobbies or preferences, interests, affinities, or location.

The web server may include a mail server or other messaging functionality for receiving and routing messages between communication management system 102 and one or more contacting user devices 1102 or agent devices 1106. An API-request server may allow a third-party system 1106 to access information from the communication management system 102 by calling one or more APIs. An action logger may be used to receive communications from a web server about a user's actions on or off communication management system 102. Information may be pushed to a contacting user device 1102 and/or agent device 1108 as notifications, or information may be pulled from contacting user device 1102 responsive to a request received from contacting user device 1102 or agent device 1108.

What is claimed is:

1. A method comprising:
monitoring a service system to generate contextual information;
determining a problem feature based on the contextual information;
receiving, from a client device associated with a contacting user, an electronic communication corresponding to the problem feature;
generating, based on the problem feature, a purpose prediction for the electronic communication; and
processing the electronic communication based on the purpose prediction.

2. The method of claim 1, wherein processing the electronic communication based on the purpose prediction further comprises:
determining an option for processing the electronic communication based on the purpose prediction
automatically executing the option for processing the electronic communication.

3. The method of claim 1, wherein generating, based on the problem feature, the purpose prediction for the electronic communication comprises:
determining a topic of the received electronic communication; and
generating, based on the problem feature and the determined topic, the purpose prediction for the electronic communication.

4. The method of claim 1, wherein generating, based on the problem feature, the purpose prediction for the electronic communication comprises:
determining contacting user information based on the received electronic communication; and
generating, based on the problem feature and the determined contacting information, the purpose prediction for the electronic communication.

5. The method of claim 4, wherein the contacting user information comprises one or more of a time associated with the electronic communication, a location associated with the client device associated with the contacting user, profile information associated with the contacting user, or service system information associated with the contacting user

6. The method of claim 1, wherein generating, based on the problem feature, the purpose prediction for the electronic communication comprises:
generating, based on the problem feature and the contextual information, the purpose prediction for the electronic communication.

7. The method of claim 6, wherein the contextual information comprises social media posts, news reports, and emergency system reports.

8. A non-transitory computer-readable medium comprising instructions that, when executed by at least one processor, cause a computer device to:
monitor a service system to generate contextual information;
determine a problem feature based on the contextual information;
receive, from a client device associated with a contacting user, an electronic communication corresponding to the problem feature;
generate, based on the problem feature, a purpose prediction for the electronic communication; and
process the electronic communication based on the purpose prediction.

9. The computer-readable medium of claim 8, wherein processing the electronic communication based on the purpose prediction further comprises:
determining an option for processing the electronic communication based on the purpose prediction
automatically executing the option for processing the electronic communication.

10. The computer-readable medium of claim 8, wherein generating, based on the problem feature, the purpose prediction for the electronic communication comprises:
determining a topic of the received electronic communication; and
generating, based on the problem feature and the determined topic, the purpose prediction for the electronic communication.

11. The computer-readable medium of claim 8, wherein generating, based on the problem feature, the purpose prediction for the electronic communication comprises:
determining contacting user information based on the received electronic communication; and
generating, based on the problem feature and the determined contacting information, the purpose prediction for the electronic communication.

12. The computer-readable medium of claim 11, wherein the contacting user information comprises one or more of a time associated with the electronic communication, a location associated with the client device associated with the contacting user, profile information associated with the contacting user, or service system information associated with the contacting user

13. The computer-readable medium of claim 8, wherein generating, based on the problem feature, the purpose prediction for the electronic communication comprises:
generating, based on the problem feature and the contextual information, the purpose prediction for the electronic communication.

14. The computer readable medium of claim 13, wherein the contextual information comprises social media posts, news reports, and emergency system reports.

15. A system comprising:
at least one processor; and
a non-transitory computer readable medium comprising instructions that, when executed by the at least one processor, cause the system to:
monitor a service system to generate contextual information;
determine a problem feature based on the contextual information;
receive, from a client device associated with a contacting user, an electronic communication corresponding to the problem feature;
generate, based on the problem feature, a purpose prediction for the electronic communication; and
process the electronic communication based on the purpose prediction.

16. The system of claim 15, wherein processing the electronic communication based on the purpose prediction further comprises:
determining an option for processing the electronic communication based on the purpose prediction
automatically executing the option for processing the electronic communication.

17. The system of claim 15, wherein generating, based on the problem feature, the purpose prediction for the electronic communication comprises:
determining a topic of the received electronic communication; and
generating, based on the problem feature and the determined topic, the purpose prediction for the electronic communication.

18. The system of claim 15, wherein generating, based on the problem feature, the purpose prediction for the electronic communication comprises:
determining contacting user information based on the received electronic communication; and
generating, based on the problem feature and the determined contacting information, the purpose prediction for the electronic communication.

19. The system of claim 18, wherein the contacting user information comprises one or more of a time associated with the electronic communication, a location associated with the client device associated with the contacting user, profile information associated with the contacting user, or service system information associated with the contacting user

20. The system of claim 15, wherein generating, based on the problem feature, the purpose prediction for the electronic communication comprises:
generating, based on the problem feature and the contextual information, the purpose prediction for the electronic communication.
